(19) United States
(12) Patent Application Publication
(10) Pub. No.: US 2010/0257106 A1
(43) Pub. Date: Oct. 7, 2010

(54) System timeline execution model development methodology for large distributed real-time embedded systems

(76) Inventors: Balasubramanian K. Iyer, Eden Prairie, MN (US); Phyllis J. Larson, Plymouth, MN (US)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 11/527,740

(22) Filed: Sep. 26, 2006

Related U.S. Application Data
(60) Provisional application No. 60/720,574, filed on Sep. 26, 2005.

(51) Int. Cl. G06Q 10/00

(52) U.S. Cl. 705/300

(57) ABSTRACT

The present invention is a project management tool uniquely suited to define and develop significant system events that can be effectively used as system test points to measure the performance and determine whether the system under design is meeting key design requirements. This methodology utilizes Synch Points in a state diagram to provide a directed graph notation and to generate a system timeline execution model automatically. The state diagram provides an improved means to decompose system event times into mechanical motion times, move transition latency times, and application software latency times. The system timeline execution model data is fed into a simulation engine to verify that the system timeline execution model is executable and confirms the dependencies are complete and accurate.

### RELATED APPLICATION

The present application claims the benefit of U.S. Provisional Application No. 60/720,574 filed Sep. 26, 2005, which is incorporated herein in its entirety by reference.

### GOVERNMENT INTEREST

The invention was made under a contract with an agency of the U.S. Government. The name of the U.S. Government agency is the United States Army and the Government contract numbers are DAAE30-95-C-009 and FCS No. 4EC2090.

### FIELD OF THE INVENTION

The present invention relates generally to product management and in particular a methodology for providing a common basis for multiple product development teams to monitor and regulate product development.

### BACKGROUND OF THE INVENTION

The management of resources for the efficient completion of complex engineering and software projects has long been a challenge to the project participants and management due to the magnitude of tasks to be accomplished. For example, the development of complex military equipment traditionally has been based on a rigid, top-down approach, originating with a publication of a customer operational requirements document. A prime contractor decomposes the operational requirements document to allocate requirements across the weapon system level, which in turn are further decomposed and allocated across the subsystem and component levels. Many time subcontractors are then assigned portions of the overall project which must mesh seamlessly with the other work of other subcontractors. This top-down, hierarchical approach ensures that customer requirements are reflected in lower-level components and become integral to an objective weapon system design. This approach, however, does very little to optimally allocate limited resources across a weapon system design, and objective characteristics of an operational design often exceed program constraints. In addition to sub-optimized designs, the top-down approach often leads to misallocated development resources and development processes that are incapable of rapidly responding to inevitable changes in operational, fiscal, and technological considerations.

Previous efforts to develop software for weapon systems have focused on stand alone simulation software or software that provides analysis at the subsystem or component level only, because methods such as the above-described top-down approach were used to manage the overall design and development process. For example, R. Carnes et al., U.S. Pat. No. 4,926,362, Airbase Sortie Generation Analysis Model (ABSGAM), describes a computer simulation model for analyzing the sortie generation capabilities and support requirements of air vehicle designs and for performing effectiveness analyses on these designs. The model cannot be used to allocate resources across a system or various subsystems or components of a design nor used concurrently and interactively with design work.

Another similar invention is described by John D. Page, et al., U.S. Pat. No. 6,370,562, Trackpoint-Based Computer-Implemented Systems and Methods for Facilitating Collaborative Project Development and Communication, which describes the creation of trackpoints created and edited by users for a collaborative project management environment. However, this model does not provide for the iterative nature of software and hardware development wherein changing parameters and performance force changes to other systems under development.

For complex, distributed, real-time large software systems typically used in military product development, there is a need to derive timing requirements and budgets for the multiple product development teams. These derived timing requirements and budgets need to be further decomposed into hardware timing budgets and software timing budgets. There is also a need for the allocated software timing budgets to take into account expected software latencies due to the electronic computing hardware architecture. The methodology to develop these timing requirements and budgets should address the involvement of the various Product Development Teams (PDTs) working on a given project by providing a common framework by which the teams can effectively participate in the product development process. There is also a need for such systems to be consistent with the iterative cycles and spiral pattern of hardware and software development.

### SUMMARY OF THE INVENTION

The present invention is a project management tool for the efficient completion of complex development projects. The System Timeline Execution Model (STEM) methodology for system timeline analysis provides a clear understanding of the sequencing and parallelism of the system events in a large complex software weapon system such as the Crusader Field Artillery System or Future Combat Systems. The present invention provides a common basis for various product development teams, such as mechanical design concept teams, systems engineering teams, and software engineering teams, to network at regular intervals to define and develop the system events and how those system events interrelate with each other.

The methodology of the present invention is uniquely suited to define and develop significant system events (“Synch Points”) that can be effectively used as system test points to measure the performance and determine whether the system under design is meeting key design requirements. This methodology utilizes Synch Points in a state diagram to provide a directed graph notation and to generate a STEM automatically. The state diagram provides an improved means to decompose system event times into mechanical motion times, move transition latency times, and application software latency times. The STEM data is fed into a simulation engine to verify that the STEM is executable and confirms the dependencies are complete and accurate.

Based on the simulation of the system events, the events that are on the critical path of a system timeline can be identified. This identification of critical path events leads to an understanding of the drivers in a system timeline and provides a vehicle to optimize the system design for a given problem space. The STEM has multiple orthogonal views of the system and they are (a) the state diagram synch point view, (b) the detailed state diagram view, (c) the detailed Gantt chart view, (d) the detailed strip chart view, (e) the spreadsheet view, and (f) the synch point chart view. The detailed strip chart view and the detailed Gantt chart view allow overlay of results from various design & integration phases of the system and ensure congruency in design from the various product development teams.

The STEM, as an executable model, aids in both the technical performance measures reporting process and the timeline budget allocation process. The STEM also directs the development of a software model that can be used in analyzing the critical computing resource estimates for a project.

The STEM creation follows a spiral development pattern with iterative cycles to improve fidelity among and provide timing budgets to the various product development teams. The state diagram methodology employs assumptions, initial conditions, and final conditions along with the synch points to provide a complete input to a system test plan that results in a 10 to 1 improvement in manpower requirements for addressing system timeline issues and addresses system software latencies that have a significant impact on system timeline requirements.

### BRIEF DESCRIPTION OF THE FIGURES

FIG. 1, is a graphical representation of the spiral and iterative development pattern for the system timeline execution model.

FIG. 2 shows the maturation levels of System Timeline Execution Model (STEM) through the life cycle of product development.

FIG. 3 is an example of a STEM state diagram for an artillery system first shot out timeline.

FIG. 4 is an example of a STEM state diagram for an artillery system maximum rate of fire timeline.

FIG. 5 is an example of a STEM state diagram for an artillery system rearm timeline.

FIG. 6 is a graphical representation of the role of a system timeline execution model in a system timeline analysis.

FIG. 7 is a state diagram Synch Point view of the STEM for a rate of fire timeline.

FIG. 8 is a detailed state diagram view of the STEM for a rate of fire timeline.

FIG. 9 is a detailed Gantt chart view of the STEM for a rate of fire timeline.

FIG. 10 is an alternate detailed Gantt chart view of the STEM for a rate of fire timeline

FIG. 11 is a detailed strip chart view of the STEM for the rammer portion for the rate of fire timeline.

FIG. 12 is a spreadsheet view of the STEM for the rammer portion for the rate of fire timeline.

FIG. 13 is a synch point chart view of the STEM for first round out timeline according to FIG. 3.

### DETAILED DESCRIPTION OF THE INVENTION

Generally, product development requires the design to meet performance and timing goals proposed by the customer. One method of influencing and monitoring how well the designs are being developed with regards to meeting the timing requirements is through system timeline analysis. A system timeline represents a sequence of system events that must take place during a given period of time as defined by the customer requirements. System timelines provide a high level view of the computing-mechanical interactions and sequencing that must occur in order for a time requirement to be met. Within the system timeline, significant system events known as “synch points” need to be defined and suitable time budgets for these synch points need to be developed to drive the efforts of various product development teams.

A solution to making the system timelines both understandable to all project members and valuable to the overall project is the use of state diagrams. The term “state diagram” is not to be confused with “state machine” as “state diagrams” do not automatically generate software. The state diagram is a graphical representation of the system events, both mechanical and software, that comprise a system timeline. The state diagram methodology for system timeline analysis provides a very clear understanding of the sequencing and parallelism of the system events in a complex, large software weapon system.

A further tool in product development is a Gantt chart, which is used to track tasks and dates relevant to a particular project. Gantt charts are found in software or hardcopy form. A Gantt chart typically uses bars to represent tasks and deadlines. For example a single bar may represent the development of a single part of a larger project. A dependency line connects the end of the bar to the beginning of the next bar in the project development thus signify that the first part must be completed before the next part may be started.

To facilitate the discussion of the features and advantages of the present invention, the following figures will use as an example the firing process of a gun system. It will be apparent, however, to one skilled in the art that the present invention may be practiced without some or all of the specific details for the development of other complex projects involving both hardware and software design. In other instances, well known process steps and/or structures have not been described in detail in order to avoid unnecessarily obscuring the present invention. In the design of a gun system, customer requirements quite often specify times that must be met by a system. A typical timing requirement for the defense industry may state, for example, that the first ammunition round of a mission must be fired within 20 seconds of the decision to fire. In order to meet a time requirement, the system mechanical and software designs must be optimal with regards to interactions and sequencing.

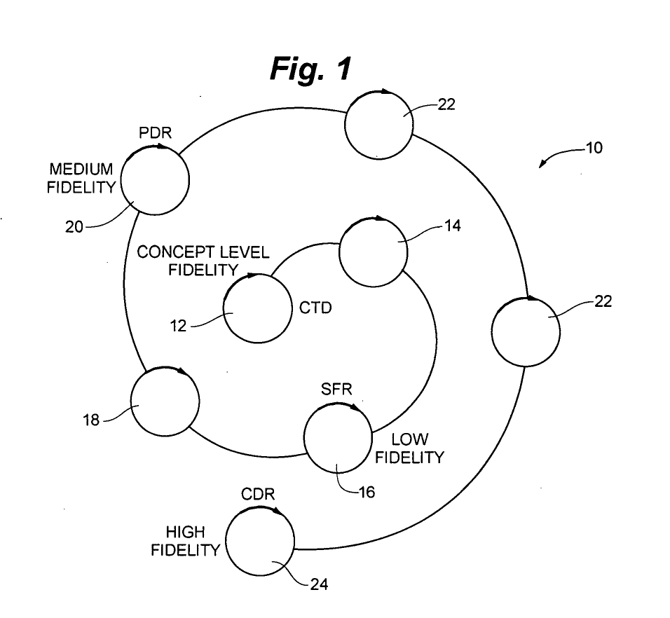

FIG. 1 illustrates the spiral and iterative development pattern for the System Timeline Execution Model (STEM) 10. The typical project begins with a concept and technology demonstration (CTD) effort 12 in order to define the scope of the project. The next step in system timeline analysis is to identify each system timeline based on review of the user requirements and input from the requirements team. State diagrams 14 for each system timeline are developed based on iterative feedback from the mechanical design engineering, controls engineering, software engineering, modeling & simulation, human factors engineering, safety engineering, and Unified Modeling Language (UML) analyses. These state diagrams 14 aid in the overall comprehension of the system complexities by the user and the various product development teams. The state diagrams 14 also assist product development teams in the understanding of the interactions and interdependencies of hardware and software as well as the timing requirements associated between them to accomplish a given activity. The state diagrams 14 show the events within the timeline along with important system triggers and provide an understanding of the concurrency that takes place during the timeline. A system functional review (SFR) 16 is then conducted based on the state diagrams 14. The iterative cycle continues as the system design plans 18 are developed and presented at a preliminary design review (PDR) 20. Typically system design variations are presented at the PDR 20 and a narrowing of the design occurs. Design steps 22 are then performed so as to develop a higher fidelity design for the critical design review (CDR) 24. Each of the identified points in FIG. 1 involve an iterative process as identified by the arrows so that accomplishing the PDR 20, for example, is not a linear process but in fact may involve multiple iterations before moving forward.

From the state diagrams, “Synch Points” are identified based on a set of goals & criteria. Synch Points are the significant system events that take place during a timeline. At the highest level of abstraction in the State Diagrams, the “Synch Points” are known as major Synch Points. At lower levels of abstraction, the major Synch Points can be decomposed into minor Synch Points such that each minor synch point can be allocated to a particular design team. The following goals are used to determining synch points: (1) Synch Points should help to track changes in the life cycle of the system; (2) Synch Points should be part of the high level abstraction of system timeline events; (3) Synch Points should help the timing budget allocation process; (4) All the critical path events should be covered in the Synch Points; and (5) Internal Synch Point sub-events, except the first sub-event, shall not be dependent on external triggers. After choosing a proposed Synch Point, the following criteria should be applied to determine if a goal is met: (1) A Synch Point is a significant system event; (2) At least one Synch Point must define the beginning of the timeline; (3) At least one Synch Point must define the ending of the timeline; (4) All critical path events should be covered by Synch Points; (5) A Synch Point is defined by start time, end time, and duration; (6) A Synch Point should have no internal wait states; (7) Each Synch Point should have a minimum number of development team owners; and (8) Synch Points should be measurable and provide meaningful budget allocations.

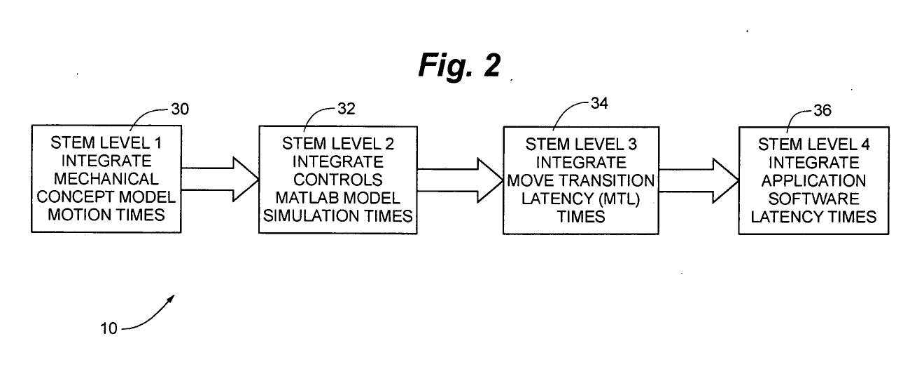

FIG. 2 presents the various levels of STEM 10 evolution. These levels can be considered as maturation levels in the STEM 10 development. Level One of STEM development 30 starts with mechanical motion times and sequencing from the design team. As Controls Engineering's Matlab simulations are developed, the timing and sequencing of events in the simulations are integrated into Level Two of the STEM 32 to increase its fidelity. STEM Level Three 34 is further enhanced by the addition of move transition latency (MTL), which is the latency produced by the move command prior to the actual mechanism motion and the move completion response after the actual mechanism motion. Software latency is added to Level Four 36 of the STEM for those events that are purely application software and do not involve hardware motions.

For example, system event times for the Synch Points can be decomposed into mechanical motion times, move transition latency times, and software latency times. These timing budgets for the Synch Points are allocated to the product development teams as requirements and design guidance. Each state diagram and Gantt chart with its synch points and a set of assumptions, initial conditions, and final conditions provide a complete package as input to the system test plan. The synch points serve as test points that can be monitored and measured throughout all development phase testing to determine if system performance will meet the system timeline requirement.

One embodiment of the present invention uses Microsoft Visio software with its drawing capabilities to create state diagrams. The Microsoft Visio software's automation library can be used to automate the creation of various diagrams including the state diagrams. Other diagramming software with the capability to organize complex ideas, processes, and systems may be utilized and are contemplated to be within the scope of the present invention.

A stencil containing shapes specific for system timelines is created and used in generating state diagrams for all system timelines. For example, each different shape on a state diagram can represent a higher-level system timeline event or roll up of events that occur for each mechanism, critical to meeting the timeline. Different colors, shading, and line types may be used to represent different aspects of the state diagram. For example, blue bubbles can represent synch points, which are significant system events. Green bubbles can signify the start of either a timeline or a sequence within a timeline. Red bubbles can denote the end of a timeline or a sequence within a timeline. Arrows or lines may be interposed between events to indicate the sequencing, triggering, and dependencies that link one event to another. State diagrams can be designed with layering so that both higher-level events and the lower-level events that make up the higher-level events can be shown.

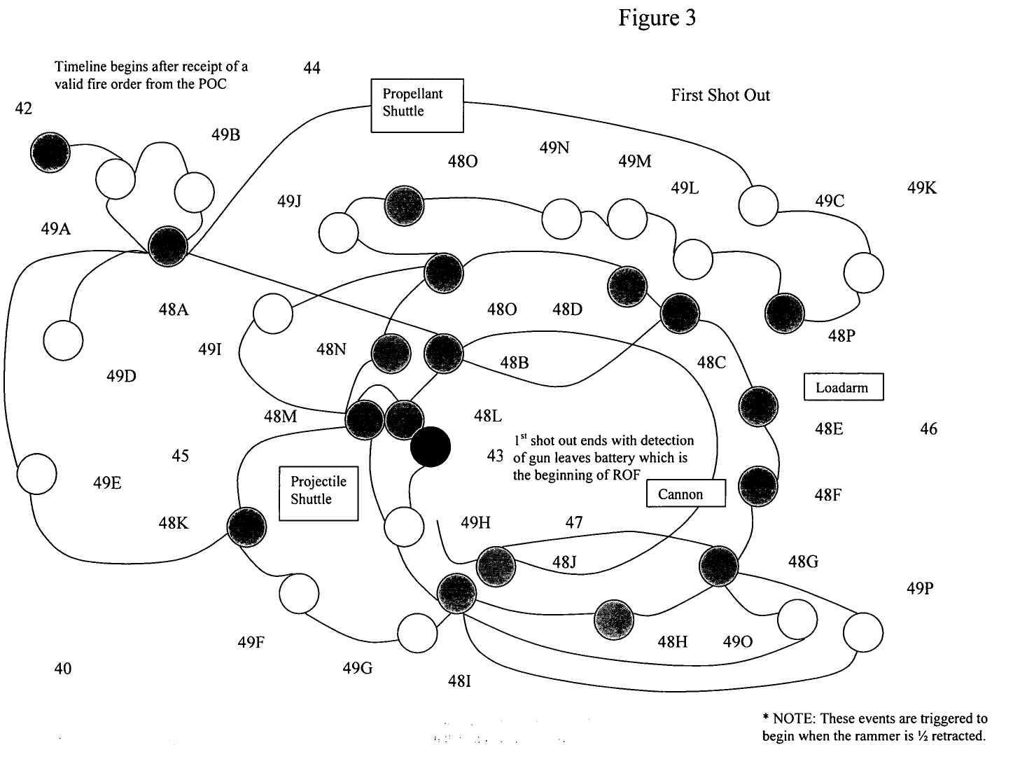

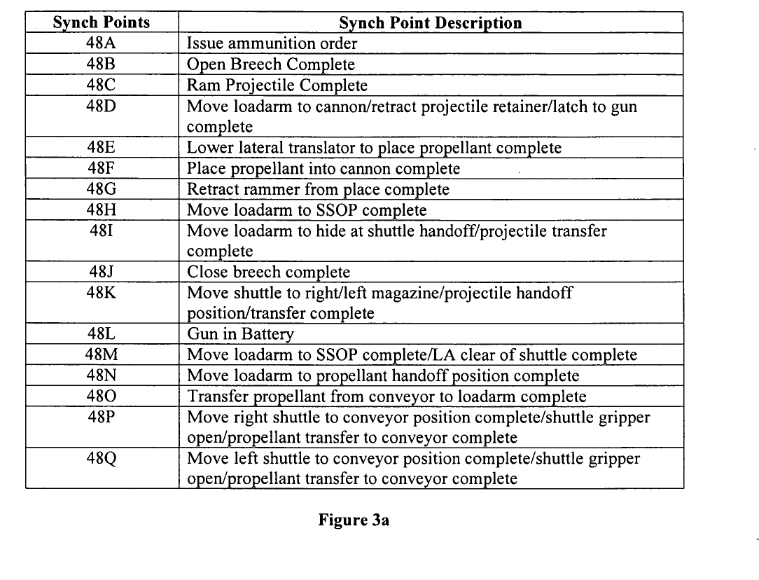

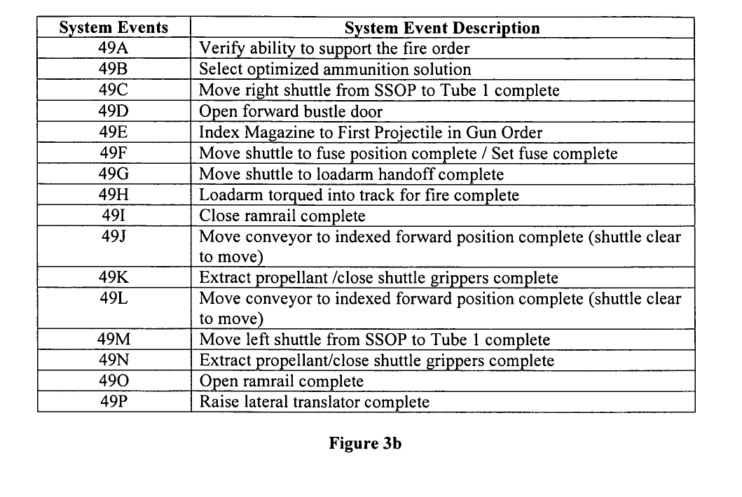

As a first example, FIG. 3 presents the state diagram 40 for an artillery system first shot out timeline. The timeline begins with the receipt of a valid fire order 42 and ends with the detection of the first shot out 43. The state diagram 40 shows the interaction of four mechanisms: the propellant shuttle 44, the projectile shuttle 45, the load arm 46, and the cannon 47. The state diagram 40 of FIG. 3 contains seventeen different Synch Points 48. As illustrated in FIG. 3, the Synch Points 48 of which the issue ammunition order 48A is exemplary are connected to other system events 49 and Synch Points 48. Arrows and lines indicate the sequencing and dependencies that trigger one event from another. With regard to Synch Point 48A Issue Ammunition Order meets the Synch Point Criteria outlined above as a significant system event. Synch Point 48A Issue Ammunition Order occurs after the completion of Verify Ability to Support the Fire Order 49A and Select Optimized Ammunition Solution 49B. Synch Point 48A Issue Ammunition Order provides input to Open Breech 48B of cannon 47, Move right shuttle 49C of the loadarm 46, Open forward bustle door 49D and Index Magazine to First Projectile in Gun Order 49E.

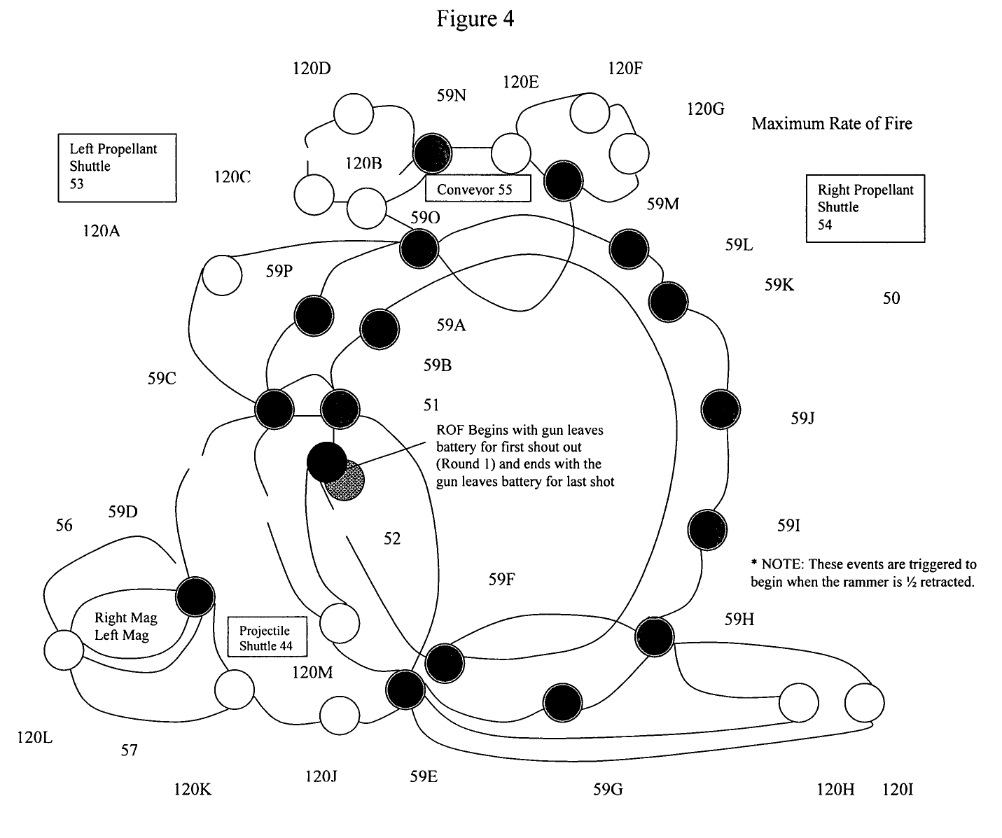

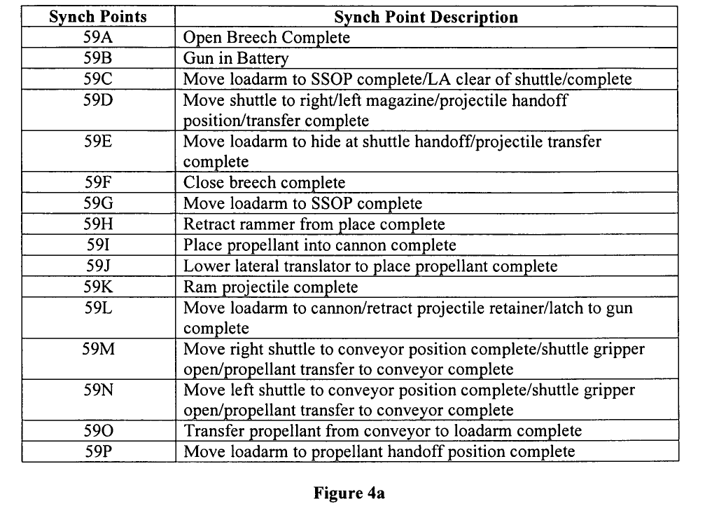

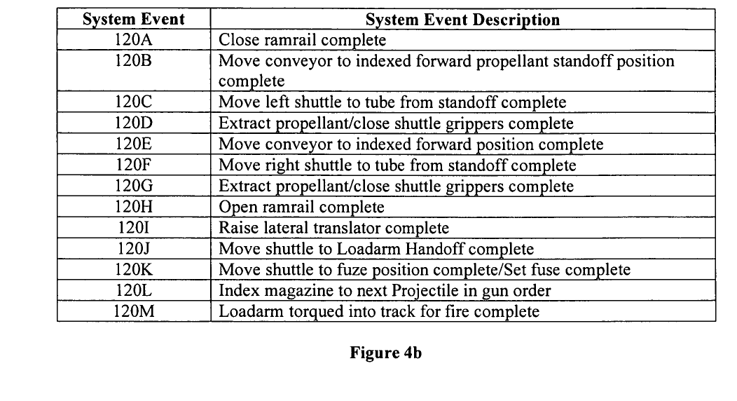

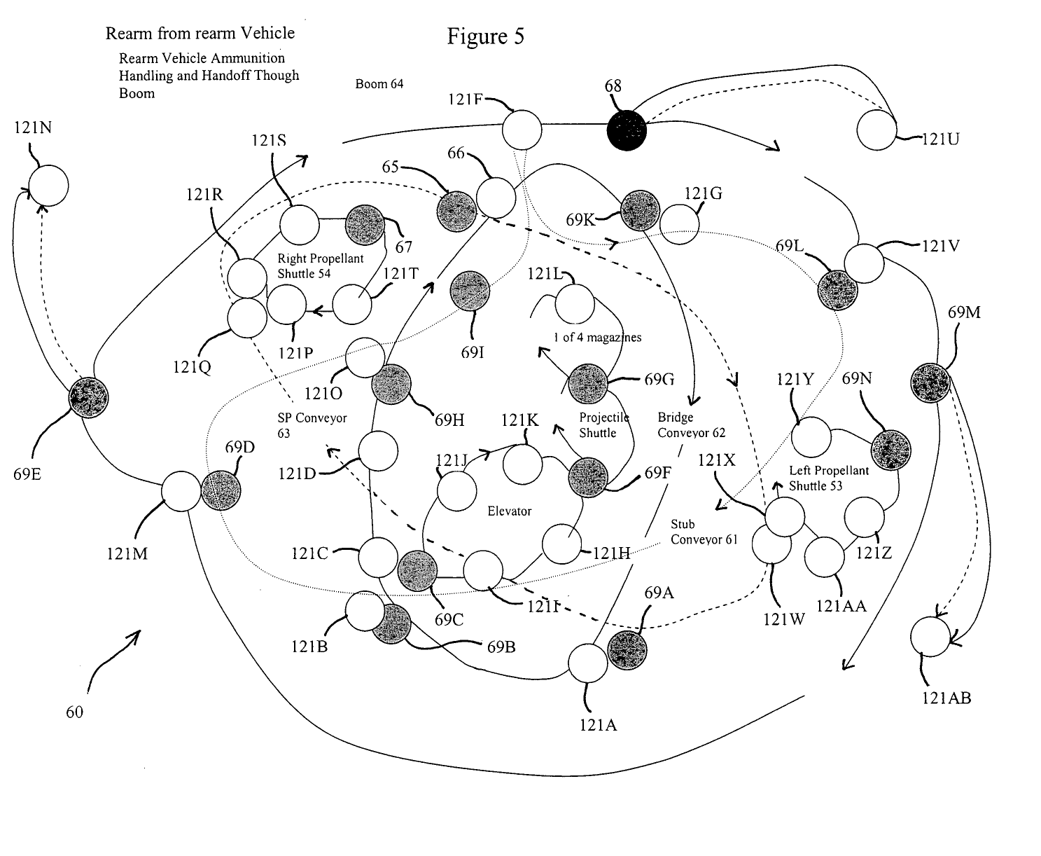

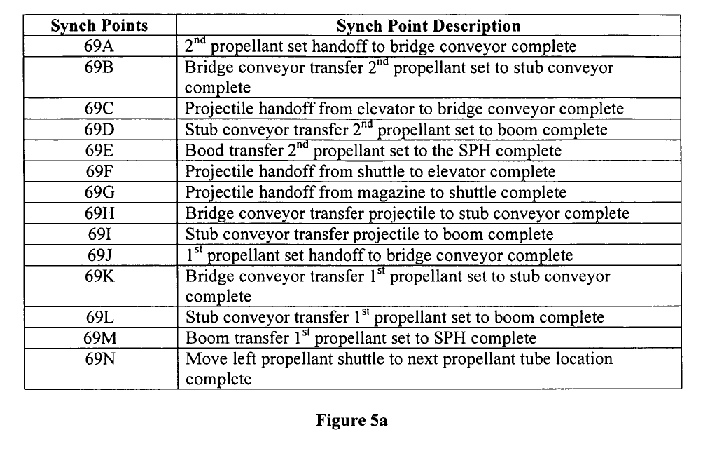

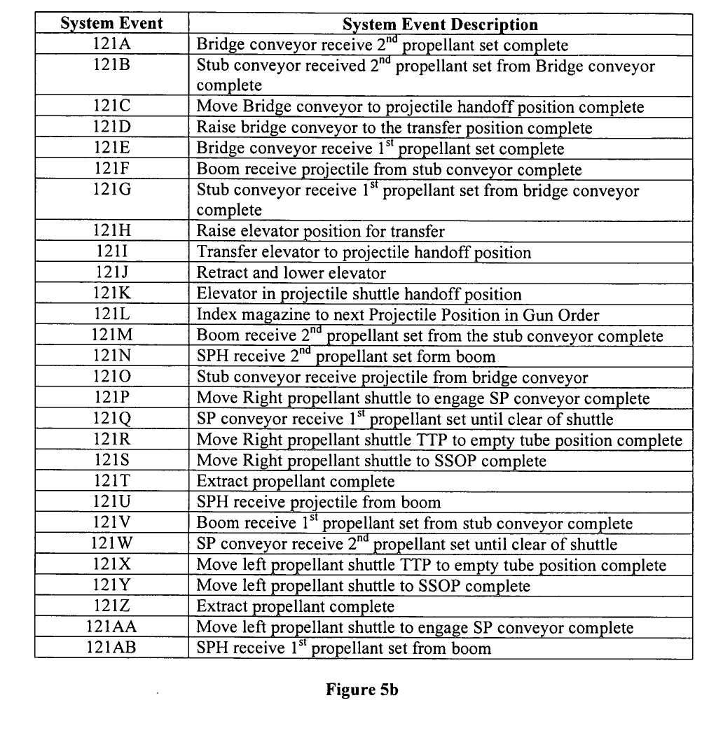

As a second example, FIG. 4 presents the state diagram 50 for an artillery system maximum rate of fire timeline. The timeline 50 begins with the detection of the first shot out event 51 and ends with the same event for the last shot out 52. FIG. 4 shows the interaction of several additional mechanisms including Left propellant shuttle 53, right propellant shuttle 54, conveyor 55 right and left magazine 56, 57 and projectile shuttle 58 to make the maximum rate of fire for the weapon. The state diagram 50 of FIG. 5 contains sixteen different synch points 59 of which open breech complete 59A is exemplary.

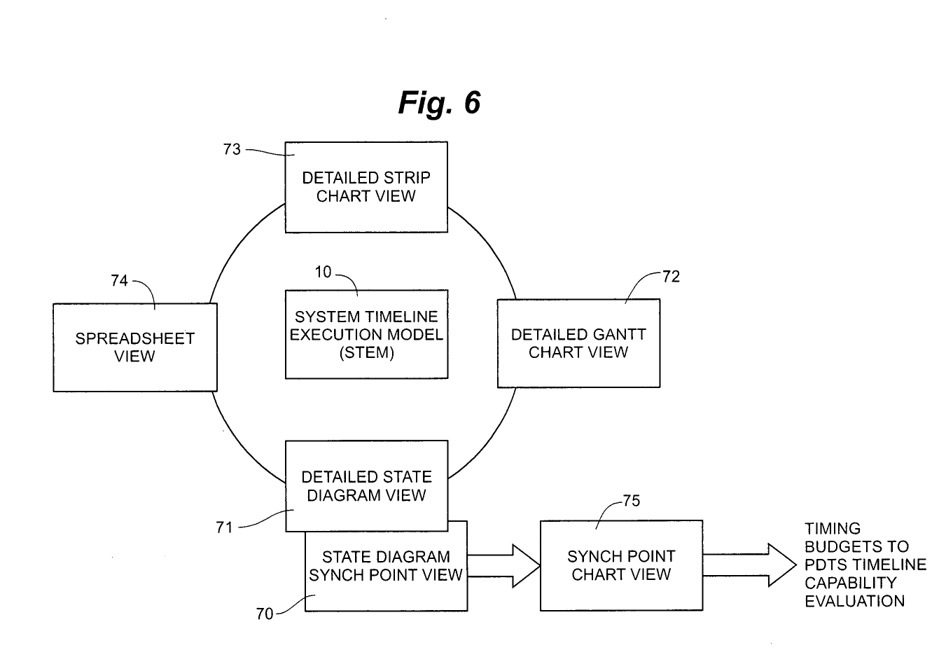

As a third example, FIG. 5 presents a portion of a state diagram 60 for an artillery system rearm timeline. The state diagram 60 represents the interactions that must take place on the rearm vehicles as the ammunition is transported to the howitzer. For ease of viewing, several of the mechanism event loops are shown with lines of varying design/thickness. The rearm timeline includes a stub conveyor loop 61, a bridge conveyor loop 62, a SP conveyor loop 63 and a boom loop 64. Where two events on different mechanism event loops 310 touch, such as 1st propellant handoff to bridge conveyor complete 65 and bridge conveyor receive 1st propellant set complete 66, a handoff of ammunition occurs between the mechanisms. The start point 67 and end point 68 of state diagram 60 of FIG. 6 are the start and end points for a sequence within the timeline, not the start and end of the timeline. The state diagram 60 of FIG. 6 contains fourteen different synch points 69 of which 2^{nd} propellant handoff to bridge conveyor complete 69A is exemplary.

FIG. 6 presents a graphical representation of the role of a System Timeline Execution Model (STEM) 10 in a system timeline analysis. Six various views of the STEM 10 are provided: state diagram synch point view 70; detailed state diagram view 71; detailed Gantt chart view 72; detailed strip chart view 73; spreadsheet view 74; and synch point chart view 75. The state diagram Synch Point view 70 and the detailed state diagram view 71 of the STEM 10 show a “directed graph” of system events with various properties. These system level events can be considered as objects with properties (data) and methods (behavior). The detailed Gantt chart view 72 shows the sequencing and parallelism involved in the various system events. The detailed strip chart view 73 shows when the various servo drives are active in a problem space like the Crusader Field Artillery System or Future Combat Systems. The spreadsheet view 74 shows the system events with their properties in spreadsheet format for easier data manipulation. The Synch Point chart view 75 shows the sequencing and timing of Synch Point events and whether the design is meeting the time requirement.

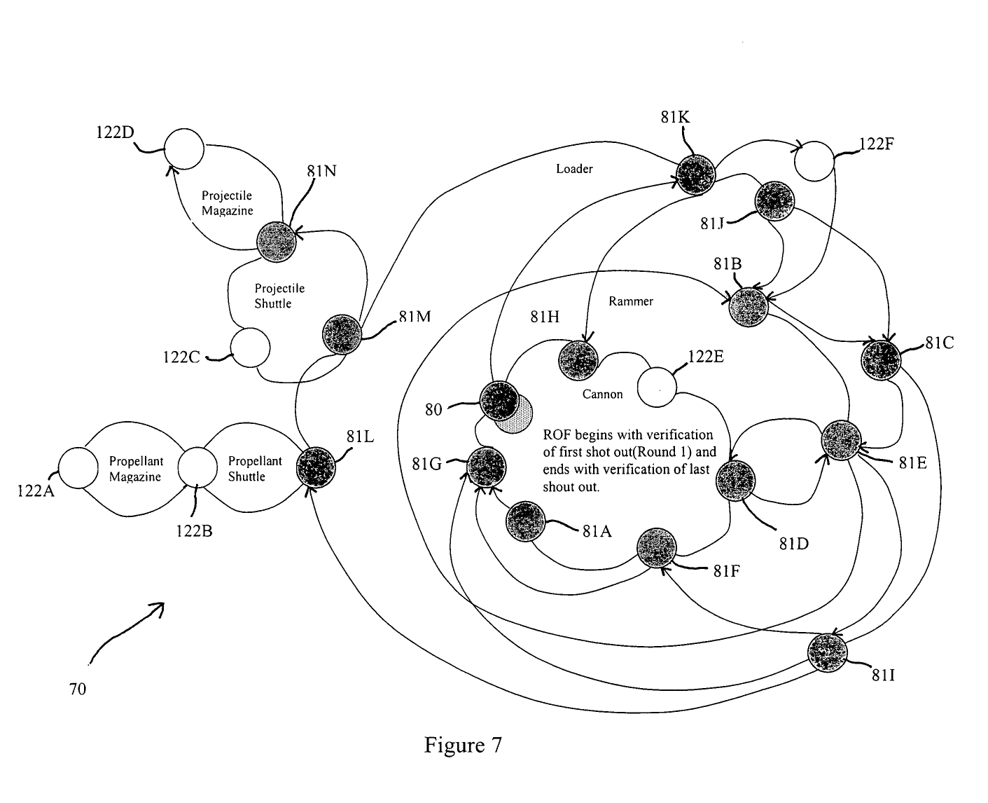

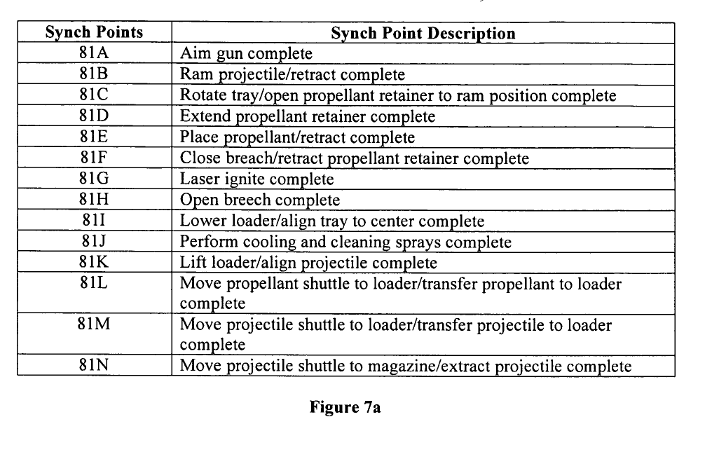

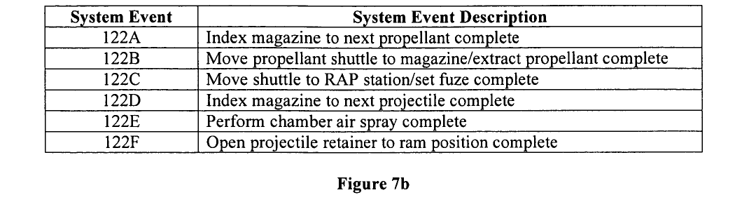

FIG. 7 presents a state diagram Synch Point view 70 of the STEM 10. As with FIG. 4, the timeline begins and ends with the same event, recoil/counter recoil complete 80. State diagram synch point view 70 of FIG. 7 contains fourteen different synch points 81 of which aim gun complete 81A is exemplary. This view concentrates on the Synch Points 81 for each system involved in completing the rate of fire step.

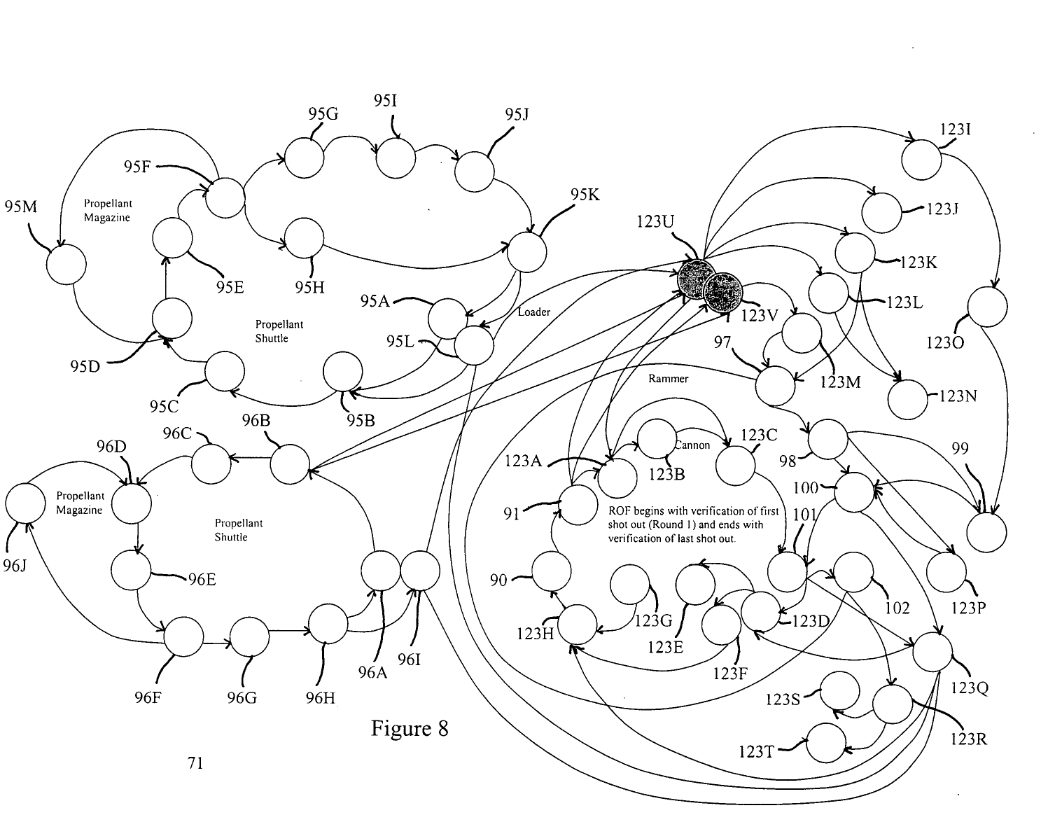

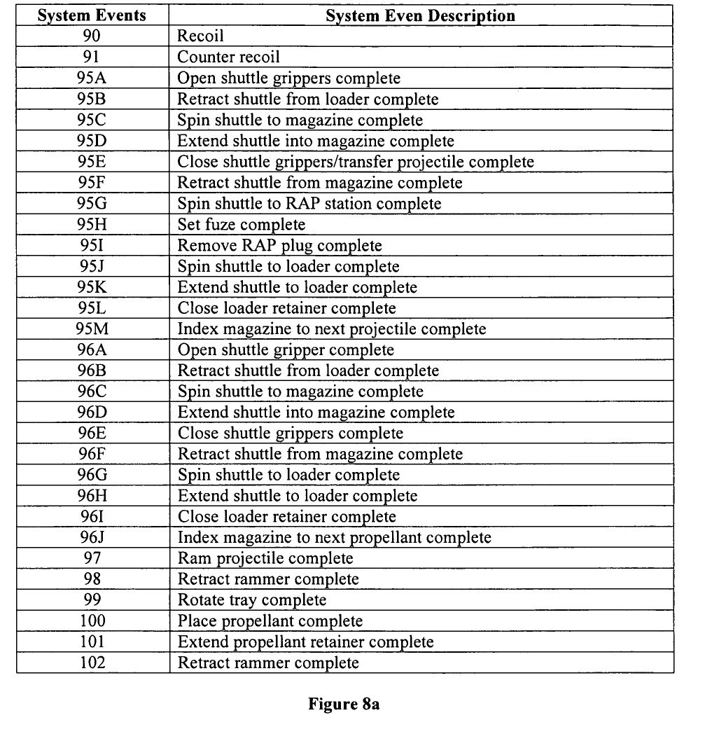

FIG. 8 presents a detailed state diagram view 71 of FIG. 7. As illustrated in FIG. 7, rate of fire (ROF) begins and ends with recoil/counter recoil complete but in FIG. 8 this step is designated by two separate state entries: recoil 90 and counter recoil 91. The Synch Points 81 in FIG. 7 summarize the output of a number of steps indicated in FIG. 8. For example, the projectile shuttle 93 includes twelve events 95 and propellant shuttle 94 includes eight events 96 illustrate the steps that must be performed.

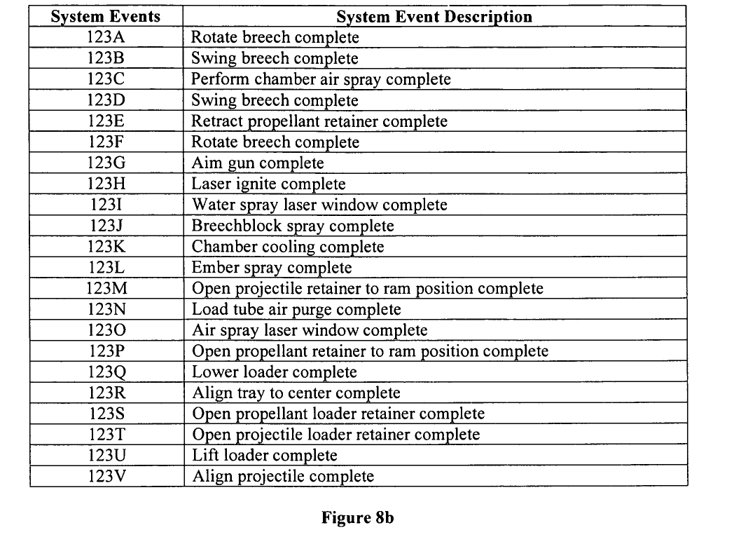

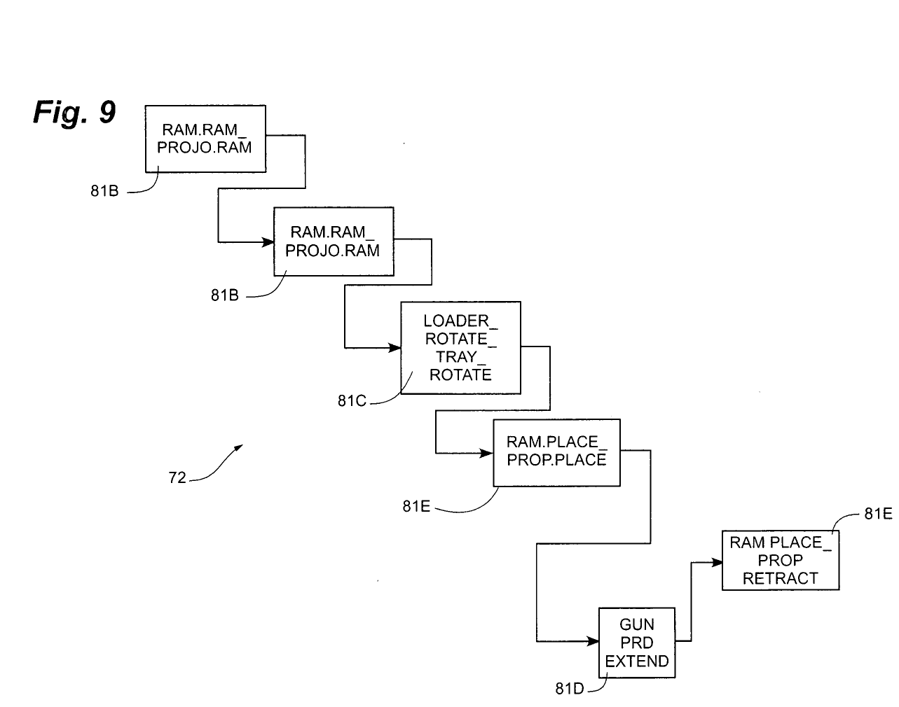

FIG. 9 presents a detailed Gantt chart view 72 of STEM 10. The detailed Gantt chart view 72 shows the sequencing and parallelism involved in the various system events. In FIG. 9, the Gantt chart 72 depicts the steps involved for Synch Point 81B Ram projectile/retract complete to Rotate tray/open propellant retainer to ram position 81C to Place propellant/retract complete 81D to Place propellant/retract complete 81E from FIG. 7. The FIG. 7 Synch Point steps correspond with FIG. 8 steps 97-102. The detailed Gantt chart data is fed into a simulation engine to verify that the STEM 10 is executable and confirms the dependencies are complete and accurate. Based on the simulation of the system events, the events that are on the critical path of a system timeline can be identified. This identification of critical path events leads to an understanding of the drivers in a system timeline and provides a vehicle for optimizing the system design in a given problem space.

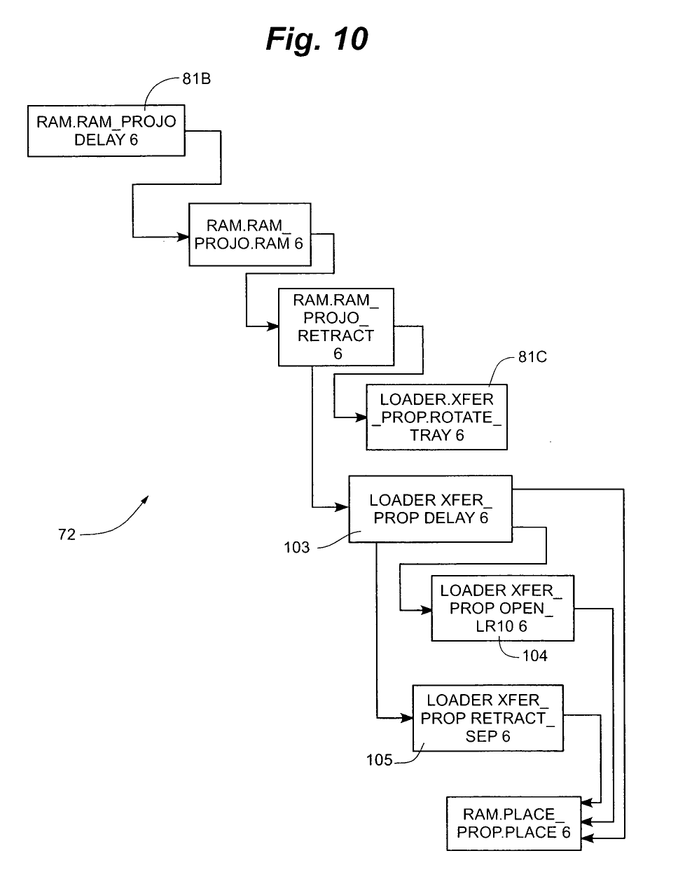

An algorithm has been developed for identifying critical path events in the detailed Gantt chart view of STEM. FIG. 10 shows an example of critical path events which maybe highlighted in “red” color for easy identification. In FIG. 10, the rotate tray Synch Point 81C is further divided into the three steps; loader xfer_prop delay 6 103, loader xfer_prop open_lt10 6 104, and loader xfer_prop retract_sep 6 105 that must be accomplished within that task

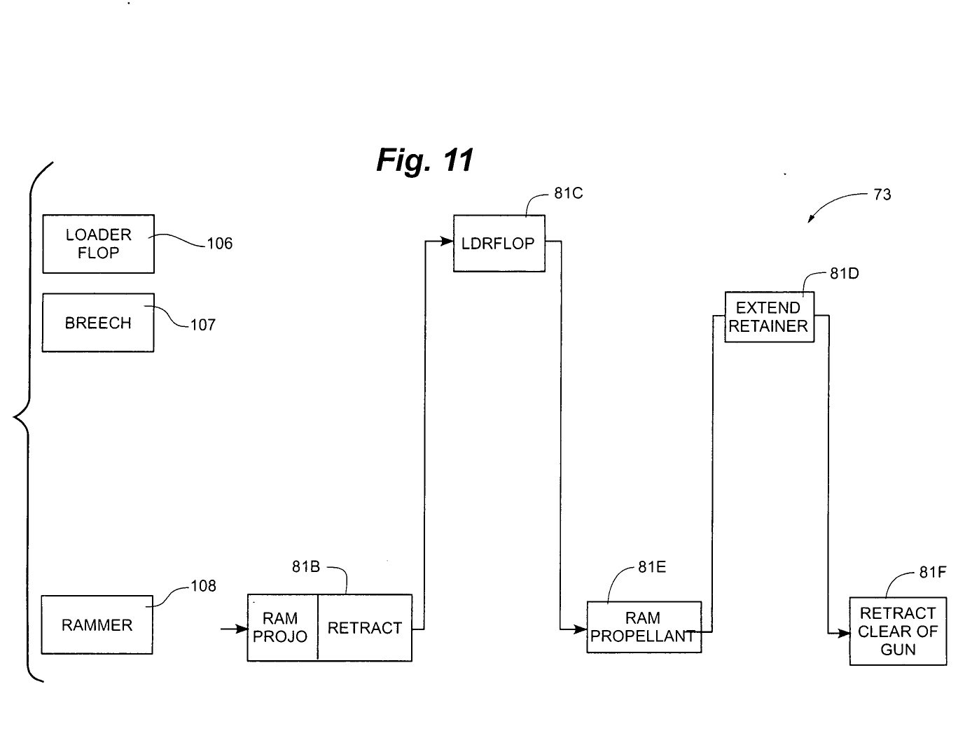

FIG. 11 presents a detailed strip chart view 73 of STEM 10. The detailed strip chart view 73 shows when the various servo drives are active in a problem space like the Crusader Field Artillery System or Future Combat Systems. This view allows overlays of system servo drive events from mechanical design perspective and from controls design perspective for optimizing system design. This view shows the sequencing and parallelism of system events in an optimized system and also provides the dominant input to determine peak power consumption in the system. Here, the mechanical systems are listed as loader flop 106, breech 107 and rammer 108. The timeline then is arranged across from the relevant mechanical system, so for example, rammer 108 activities include ram projectile/complete 81B, ram propellant 81E and retract clear of gun 81F.

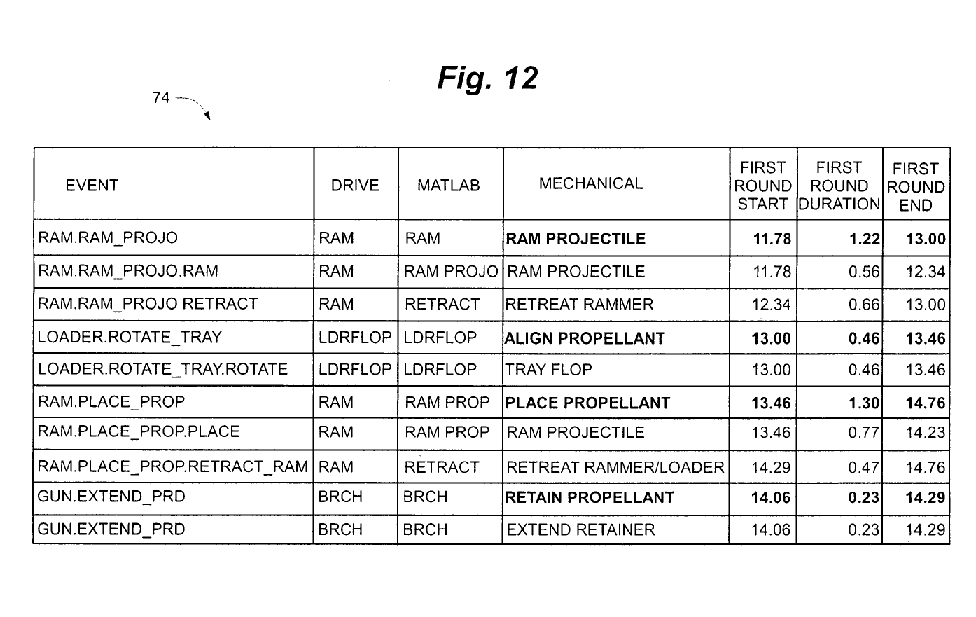

FIG. 12 presents a spreadsheet view 74 of STEM 10. The format of the spreadsheet view 74 facilitates data manipulation. The spreadsheet view allows for an examination of the drives, and timing involved in completing an event.

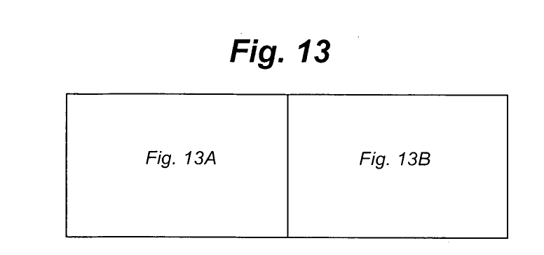

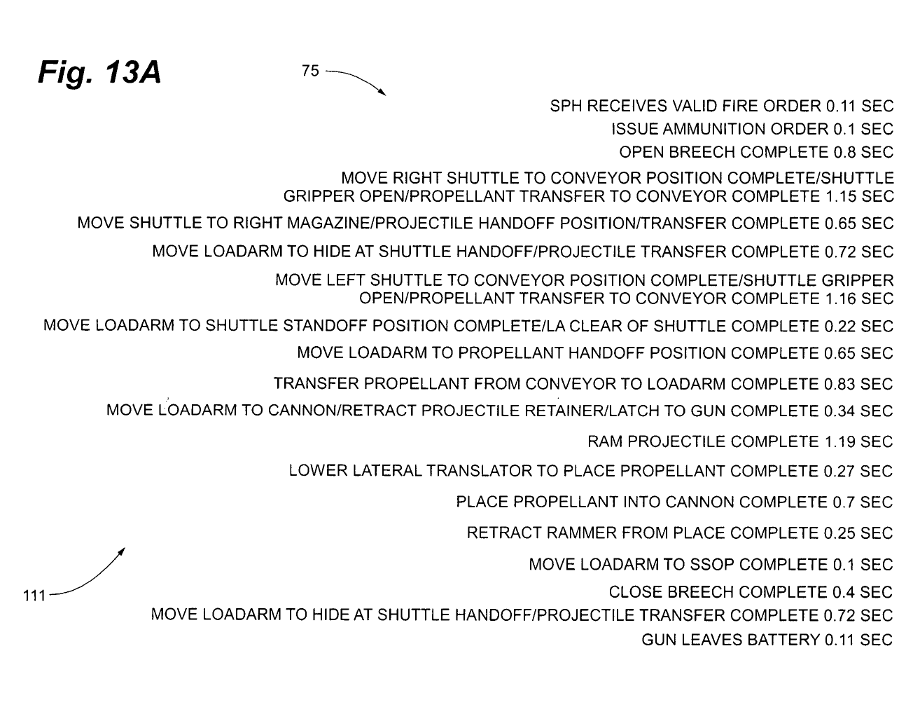

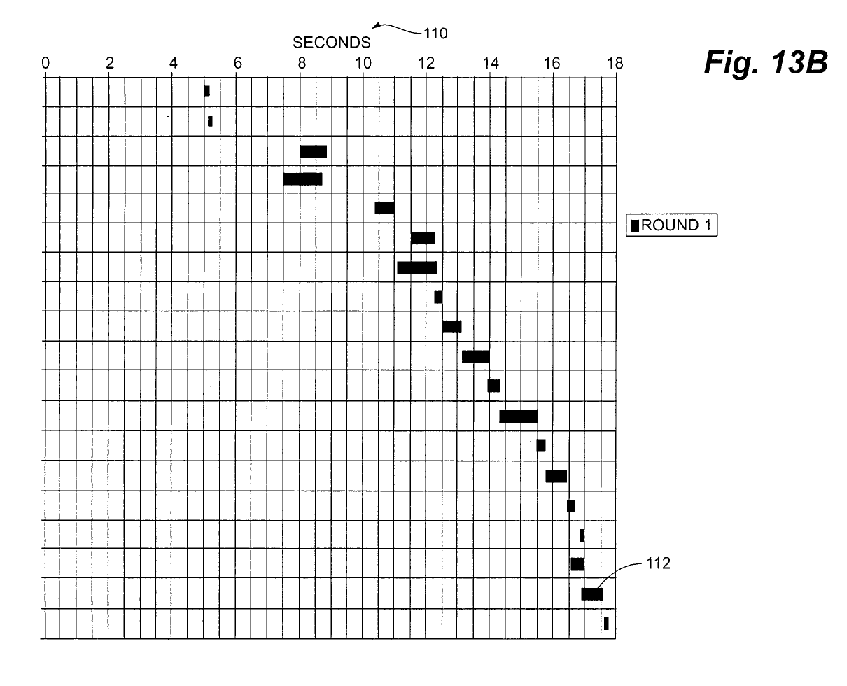

FIG. 13 presents a Synch Point chart view 75 for the first round out timeline produced from the state diagram in FIG. 3. The horizontal axis 110 on the synch point chart view 75 represents time in seconds for the duration of the timeline. The vertical axis 111 represents the Synch Points 59 that occur during the timeline. The horizontal bars 112 show the timing budgets for Synch Points 59 and whether the overall design is meeting the time requirement. The sequencing and concurrency of the Synch Points 59 can also be seen with respect to time. The synch point chart view 75 is a useful tool for tracing how well the Synch Points 59 are doing against budgets as the design travels through the many levels of integration and testing. Actual measurements of the Synch Points 59 taken during testing in the various design & integration phases can be superimposed as overlays on the original synch point chart view 75 in order to compare the measurements against the budgets. If the design isn't meeting the Synch Point 59 budgets and/or the overall timeline, then the existing problem(s) can be identified on the synch point chart view 75 and steps for corrective action can be taken.

Each State Diagram and Gantt chart with their synch points and a set of “assumption,” “initial conditions” and “final conditions” provide a complete package as input to the system test plan.

It is obvious to those skilled in the art that other embodiments of the method disclosed in addition to the ones described herein are indicated to be within the scope and breadth of the present application. Accordingly, the Applicant tends to be limited only by the claims appended hereto.

1. The method for facilitating a collaborative design effort between a plurality of product development teams, said product development teams having responsibilities for at least mechanical design, systems engineering design and software design, said method being implement on a networked computer system accessible by the individual product development teams, the method comprising;
identifying a plurality of design performance criteria for the project, said design performance criteria based on a set of user requirements,
generating a system timeline analysis to accomplish each of the design performance criteria,
generating a state diagram for each system timeline,
selecting a plurality of synch points from each system timeline, said synch points used as a measure of how the system meets the design performance criteria,
determining a time budget for each synch point,
providing a system timeline execution model with the synch points for each system timeline,
generating a plurality of tools for the product development teams to define and create an improved system timeline and monitor interactions between the product development teams, and
updating the system timeline execution model to reflect the improved system timeline.

2. The method of claim 1 wherein selecting the synch points includes evaluating each system timeline event based on the following criteria;
(1) a Synch Point is a significant system event;
(2) At least one Synch Point must define the beginning of the system timeline;
(3) At least one Synch Point must define the ending of the system timeline;
(4) All critical path events should be covered by Synch Points;
(5) A Synch Point is defined by start time, end time, and duration;
(6) A Synch Point should have no internal wait states;
(7) Each Synch Point should have a minimum number of development team owners; and
(8) Synch Points should be measurable and provide meaningful budget allocations.

3. The method of claim 1 wherein the plurality of tools includes a detailed state diagram view.

4. The method of claim 1 wherein the plurality of tools includes a detailed Gantt chart view.

5. The method of claim 1 wherein the plurality of tools includes a detailed strip chart view.

6. The method of claim 1 wherein the plurality of tools includes a detailed spreadsheet view.

7. The method of claim 1 wherein the plurality of tools includes a state diagram Synch Point view.

8. The method of claim 1 wherein the plurality of tools includes a Synch Point chart view.
